(19) United States
(12) Patent Application Publication
(10) Pub. No.: US 2014/0055366 A1
(43) Pub. Date: Feb. 27, 2014

(54) KEYBOARD DEVICE AND LIGHT GUIDE FILM LAYER THEREOF

(71) Applicant: HON HAI PRECISION INDUSTRY CO., LTD., New Taipei (TW)

(72) Inventor: KUO-HSIANG OUYANG, New Taipei (TW)

(73) Assignee: HON HAI PRECISION INDUSTRY CO., LTD., New Taipei (TW)

(21) Appl. No.: 13/949,238

(22) Filed: Jul. 24, 2013

(30) Foreign Application Priority Data
Aug. 23, 2012 (TW) 101130721

(51) Int. Cl. F21V 8/00; G06F 3/02

(52) U.S. Cl. CPC G02B 6/0081; G06F 3/0202
USPC 345/170; 362/23.03

(57) ABSTRACT

A keyboard device provided by the present disclosure comprises a key layer, a dome layer, and a light guide film layer positioned between the key layer and the dome layer. The light guide film layer comprises a light guide film and a rubber layer fixed on a lower surface of the light guide film. The light guide film and the rubber layer are integrally formed together by molding. The rubber layer has an upper surface facing the light guide film and a lower surface facing away from the light guide film. The lower surface of the rubber layer defines at least one receiving groove.

A light guide film layer applied to a keyboard device is also provided by the present disclosure.

### BACKGROUND

1. Technical Field

The present disclosure relates to a keyboard of electronic devices, and, particularly, to a keyboard device and a light guide film layer of the keyboard device.

2. Description of Related Art

Portable electronic devices such as mobile phones include a keyboard. The keyboard includes a number of LEDs as light sources to provide light in darkness. In order to reduce the number of LEDs and save cost, a light guide film is used to guide light beams. As shown in FIG. 1, the traditional keyboard 10 of a mobile phone comprises a key layer 11, a rubber layer 12, a light guide film layer 13, a dome layer 14, a circuit board 15 fixing a number of LEDs, which are arranged from top to bottom. The key layer 11 includes a number of keys 111. The rubber layer 12 is made of translucent rubber. The light guide film layer 13 includes a number of recesses 131 and each of the recesses 131 corresponds to one of the keys 111. The light beams emitted from the LEDs are guided by the light guide film layer 13, to pass through the concave hole 131 and the rubber layer 12 to light the keys 111. The dome layer 14 comprises a number of dome-shaped members 141. Each dome sheet 141 corresponds to one of the keys 111. The rubber layer 12 of the traditional keyboard 10 is positioned between the key layer and the light guide film layer, which increases the thickness of the keyboard and is not good for miniaturization of the electronic device.

Therefore, what is needed is a keyboard device and a light guide film layer thereof alleviating the limitations described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross-sectional view of a keyboard of an electronic device in related art.

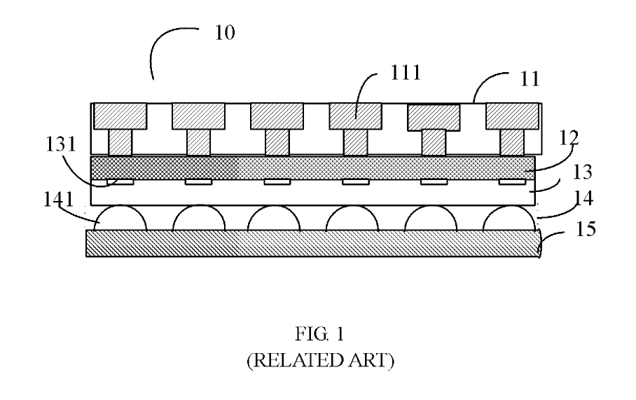

FIG. 2 is a cross-sectional view of a keyboard device, in accordance with an exemplary embodiment of the present disclosure.

FIG. 3 is an exploded view of the keyboard device of FIG. 2.

FIG. 4 is a cross-sectional view illustrating light beams passing through a light guide film of the keyboard device of FIG. 2.

FIG. 5 is a flowchart of a manufacturing method of the light guide film of the keyboard device of FIG. 2.

FIG. 6 is a cross-sectional view with the light guide film layer formed in a mould, in accordance with an exemplary embodiment.

### DETAILED DESCRIPTION

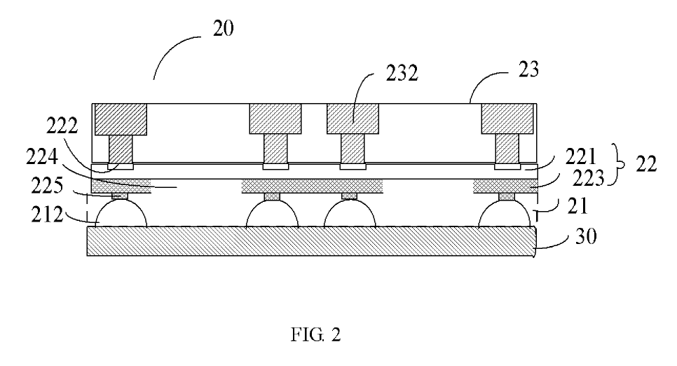

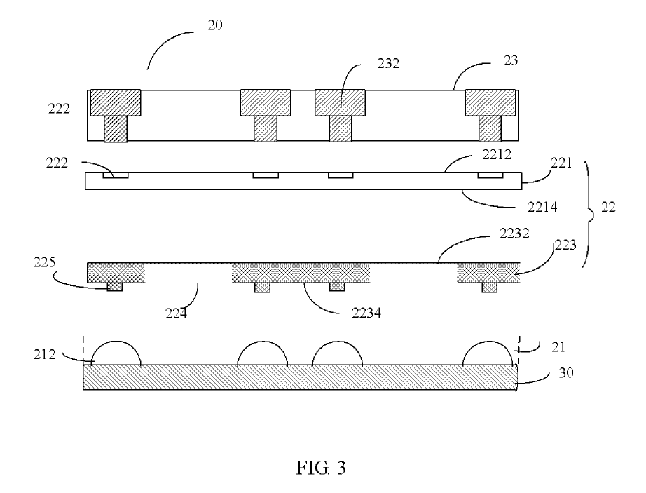

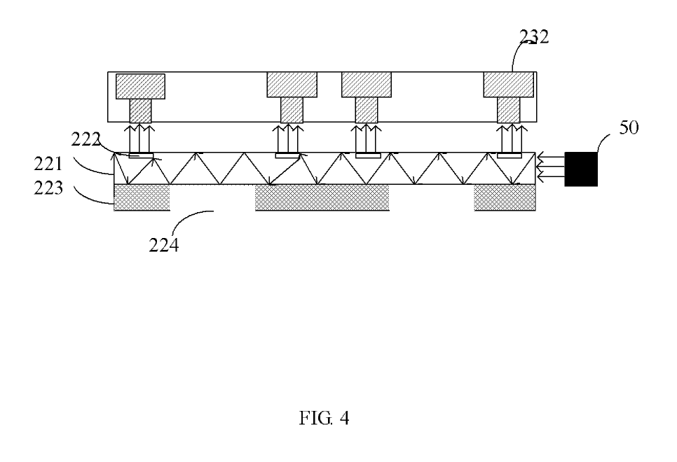

Referring to FIGS. 2-4, a keyboard device 20 in accordance with an exemplary embodiment is illustrated. The keyboard device 20 is for fixing in an electronic device, for the input of information or commands. The keyboard device 20 comprises a printed circuit board 30, a dome layer 21, a light guide film layer 22 and a key layer 23, arranged in that order from the bottom to the top.

The dome layer 21 includes a number of dome-shaped members 212 fixed on the printed circuit board 30. The dome-shaped members 212 are made of metal material. The key layer 23 includes a number of press keys 232. The press key 232 is made of silica material. Each press key 232 is marked with at least one alphanumeric character. Each of the dome-shaped members 212 is aligned with one of the press keys 232.

The light guide film layer 22 includes a light guide film 221 and a rubber layer 223. The light guide film 221 is fixed on the rubber layer 223 and faces the key layer 23. The light guide film 221 and the rubber layer 223 are integrally formed together by molding.

The light guide film 221 can be made of a material selected from the group consisting of polycarbonate (PC), thermoplastic polyurethane (TPU), and silicon. The light guide film 221 has an upper surface 2212 and a lower surface 2214, and the upper surface 2212 faces the key layer 23 and a number of recesses 222 are defined on the upper surface 2212. The recesses 222 are spaced from each other. The press key 232 is fixed on the light guide film layer 22 and aligned with one of the respective recesses 222.

The keyboard device 20 further includes a number of light emitting units 50. The light emitting units 50 are light sources of the keyboard device 20 and electronically connected to the printed circuit board 30. The light guide film 221 includes a light incident face substantially perpendicular to the lower surface 2214 thereof. The light emitting units 50 are configured to emit light beams to the light incident face, and the lower surface 2214 of the light guide film 221 are configured to reflect and direct the light beams to exit the light guide film 221 through the recesses 222 to light the press keys 232. Light beams emitted from the light emitting units 50 are reflected by the light guide film 221 to pass through the recesses 222, thus illuminating the light guide film 221. Therefore, light beams emitted from the light emitting unit 50 need not pass through the rubber layer 223 and can directly light the press keys 111. Thus, the light guide film layer 22 improves the transmission efficiency of light beams emitted by the light emitting unit 50, and less power is required for the same degree of illumination. In this embodiment, the light emitting unit 50 includes a number of light emitting diodes (LEDs).

In this embodiment, the printed circuit board 30 includes various electronic components for implementing a variety of functions. These electronic components can be mounted on the printed board 30 and around the dome-shaped members 212. The rubber layer 223 has an upper surface 2232 and a lower surface 2234, and the lower surface 2234 faces away from the light guide film 221 and a number of receiving grooves 224 are defined on the lower surface 2234. The receiving grooves 224 correspond to the electronic components to receive the electronic components. Thus, the receiving grooves 224 provide space which accommodates the electronic components, which saves more space for the keyboard device 20.

In another embodiment, the lower surface 2234 of the rubber layer 223 further includes a number of protruding elements 225 aligned with the corresponding dome-shaped members 212. When a user presses the press key 111, the protruding element 225 abuts the dome-shaped members 141, thus a tactile experience is provided by the press key 111.

The keyboard device 20 provided by the present disclosure has following advantages: firstly, the light guide film 221 and the rubber layer 223 of the keyboard device 20 are integrally formed together by molding, the thickness of the light guide film layer 22 is thinner than that of the light guide film 221 and the rubber layer 223 of a traditional keyboard, where these components are formed individually, thus, the thickness of the whole keyboard device can be reduced. Secondly, the light guide film 221 is fixed on the upper surface of the rubber layer 223, thus improving transfer efficiency of the light beams. Thirdly, the rubber layer 223 includes receiving grooves 224 corresponding to the electronic components of the printed circuit board 30 to receive the electronic components, which saves space for the keyboard device 20.

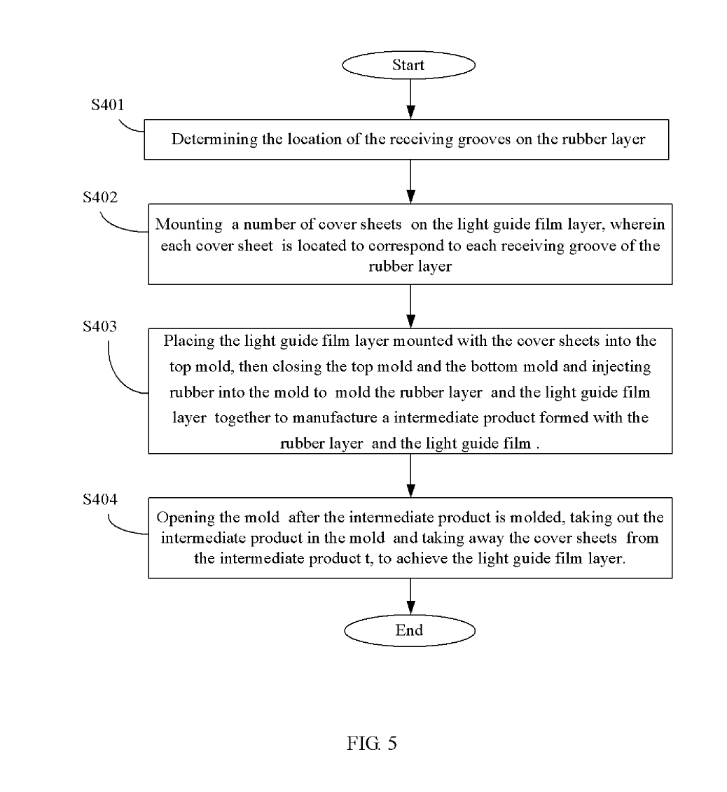

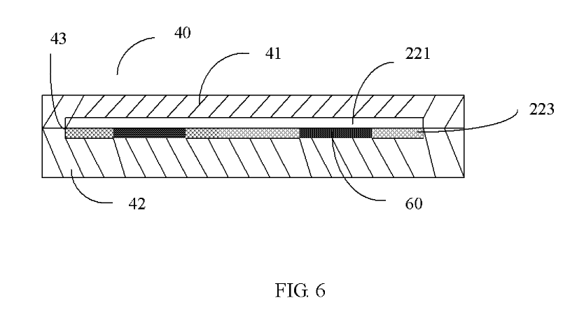

Referring to FIGS. 5 and 6, a method of manufacturing the light guide film layer 22 is illustrated. A mold 40 configured to manufacture the light guide film layer 22 comprises a top mold 41 and a bottom mold 42. The top mold 41 and the bottom mold 42 cooperatively form a molding cavity 43. The molding cavity 43 is configured to mold the light guide film layer 22. The light guide film layer 22 includes a light guide film 221 and a rubber layer 223 integrally formed on a surface of the light guide film 221. The rubber layer 223 includes a number of receiving grooves 224 opposite the light guide film 221. The method for manufacturing the light guide film layer 22 includes following steps:

In step S401: determining the location of the receiving grooves 224 on the rubber layer 223. In the embodiment, the locations of the receiving grooves 224 correspond to the locations of electronic components mounted on printed circuit board 30.

In step S402: mounting a number of cover sheets 60 on the light guide film 221, wherein each cover sheet 60 is located to correspond to each receiving groove 224 of the rubber layer 223. The cover sheet 60 may be made of a material selected from the group consisting of resin and metal which has a melting point higher than that of the rubber layer 20.

In step S403: placing the light guide film 221 mounted with the cover sheets 60 into the top mold 41, then closing the upper mold 41 and the bottom mold 42 and injecting rubber material into the mold 40, to mold the rubber layer 223 and the light guide film 221 together to manufacture a intermediate product formed with the rubber layer 223 and the light guide film 221.

In step S404: opening the mold 40 after the intermediate product is molded, taking out the intermediate product in the mold 40 and taking away the cover sheets 60 from the intermediate product, to achieve the light guide film layer 22.

The manufacturing method of the light guide film layer 22 produces the rubber layer 223 fixed on a surface of the light guide film 221 and integrally formed together by a molding process. Cover sheets 60 must be put on the light guide film 221 corresponding to the location of receiving grooves of the rubber layer 223 before molding the light guide film layer 22, and the cover sheets 60 removed from the light guide film layer 22 after the light guide film layer 22 is molded. The method of manufacturing the light guide film layer is very simple and efficient, thus saving the cost and time of manufacture.

Although the present disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure. Therefore, the scope of the appended claims should not be limited to the description of the preferred embodiments described above.

What is claimed is:

1. A keyboard device, comprising:
a key layer comprising a plurality of press keys;
a dome layer comprising a plurality of dome-shaped members aligned with the respective press keys; and
a light guide film layer positioned between the key layer and the dome layer; wherein the light guide film layer comprises a light guide film and a rubber layer fixed on a lower surface of the light guide film, the light guide film and the rubber layer are integrally formed together by molding, the rubber layer has an upper surface facing the light guide film and a lower surface facing away from the light guide film, the lower surface of the rubber layer defines at least one receiving groove.

2. The keyboard device as described in claim 1, wherein the light guide film is made of a material selected from the group consisting of polycarbonate, thermoplastic polyurethane, and silicon.

3. The keyboard device as described in claim 1, wherein the upper surface of the light guide film defines a plurality of recesses aligned with the respective press keys.

4. The keyboard device as described in claim 3, wherein the keyboard device further comprises a plurality of light emitting units and a printed circuit board, the light emitting units are electrically connected with the printed circuit board to illuminate the light guide film.

5. The keyboard device as described in claim 4, wherein the printed circuit board is fixed under the dome layer.

6. The keyboard device as described in claim 4, wherein the light guide film includes a light incident face substantially perpendicular to the lower surface thereof, the light emitting units configured to emit light beams to the light incident face, the lower surface of the light guide film configured to reflect and direct the light beams to exit the light guide film through the recesses to light the press keys.

7. The keyboard device as described in claim 4, wherein the printed circuit board comprises electronic components mounted in the receiving grooves.

8. The keyboard device as described in claim 1, wherein the lower surface of the rubber layer comprise a plurality of protruding elements, each of the protruding element aligned with the corresponding one of the dome-shaped members.

9. A light guide film layer of a keyboard device, comprising:
a light guide film; and
a rubber layer fixed on the light film, wherein the light film and the rubber layer are integrally formed together by molding, and a surface of the rubber layer facing away from the light guide film defines at least one receiving groove.

10. The light guide film layer as described in claim 9, wherein the light guide film is made of a material selected from the group consisting of polycarbonate, thermoplastic polyurethane, and silicon.

11. The light guide film layer as described in claim 9, wherein a surface of the light guide film facing away from the rubber layer comprises a plurality of recesses to allow light beams to exit therefrom.
